(19) United States
(12) Patent Application Publication
(10) Pub. No.: US 2011/0247495 A1
(43) Pub. Date: Oct. 13, 2011

(54) Gas Adsorber For Use In Gas Storager

(75) Inventors: Doron Marco, Tel Aviv (IL); Shany Peled, Netanya (IL)

(73) Assignee: Doron Marco, Tel Aviv (IL)

(21) Appl. No.: 12/765,314

(22) Filed: Apr. 22, 2010

Related U.S. Application Data
(60) Provisional application No. 61/321,625, filed on Apr. 7, 2010.

(51) Int. Cl. B01D 53/02; C01B 31/08; B65B 3/00; B01J 20/08; B01J 20/22; B01J 20/16; B01J 20/00; B01J 20/10

(52) U.S. Cl. 95/127; 95/90; 95/139; 95/129; 95/140; 95/116; 502/400; 502/416; 502/405; 502/415; 502/401; 502/62; 206/7

(57) ABSTRACT

The present invention relates to a structure having a core-shell configuration. The core comprises a predetermined adsorber solid material, and the shell at least partially surrounding the core comprises a predetermined humidity controlling material, thereby enabling using said adsorber solid material for interacting with and thus storing therein a predetermined adsorbable gas under desired environmental conditions. The invention also discloses a pressure vessel for use in storing at least one gas. The pressure vessel comprises an entrance/exit opening for allowing entrance or exit therethrough of at least one adsorbable gas to be stored at a pressurized state; a cavity coupled to said entrance/exit opening and configured for feeding and containing therein a storing medium, said storing medium comprising: an adsorber solid material selected to adsorb adsorbable molecules of said at least one gas; and a humidity controlling material being selected for maintaining a predetermined level of humidity in said cavity.

### FIELD OF THE INVENTION

This invention relates to the field of gas adsorber for use in gas storage and of pressure vessels to be used with such gas adsorber.

### BACKGROUND OF THE INVENTION

Pressure vessels are used in a variety of applications in both industry and the private sector. They appear in these sectors as industrial compressed air receivers and domestic hot water storage tanks. Other examples of pressure vessels are: diving cylinder, recompression chamber, distillation towers, autoclaves and many other vessels in mining or oil refineries and petrochemical plants, nuclear reactor vessel, habitat of a space ship, habitat of a submarine, pneumatic reservoir, hydraulic reservoir under pressure, rail vehicle airbrake reservoir, road vehicle airbrake reservoir and storage vessels for liquified gases such as ammonia, chlorine, propane, butane and LPG.

The use of highly adsorptive materials as vehicles for the gas in transporting, storage and handling the same has been investigated as disclosed for example in U.S. Pat. No. 1,608,155. Adsorptive materials are such as having the capacity or power of condensing gas in large amounts on their exterior surfaces or on the surfaces within their pores, interstices, or cracks or otherwise within the particles of the material in such as manner as to concentrate large quantities of gas within small space.

### GENERAL DESCRIPTION

Industrial adsorbents are typically hydrophilic materials of the oxygen-containing compounds class such as silica gel and zeolites. However, such hydrophilic materials are very sensitive to humidity. To be efficient, the adsorbents are to be used in environmental conditions in which the level of humidity does not raise above 1%. Such environmental conditions are difficult to obtain in regular industrial environment. The gas storage devices in which the adsorbent has to be introduced are generally dried before the introduction of the adsorbent material, but in many cases the level of humidity cannot be maintained below 1% during the introduction of the gas, the storage itself as well as during the supplying process in which the gas is expelled of the gas storage device. The adsorbent material adsorbs humidity instead of the selected absorbable gas, reducing significantly the efficiency of the adsorbent material.

There is a need in the art to provide a hydrophilic adsorbent material which can be efficiently used with an adsorbable material even when the environmental conditions in which such adsorbent material are not optimal. The present invention provides a structure having a core-shell configuration, the core comprising a predetermined adsorber solid material, and the shell at least partially surrounding the core comprising a predetermined humidity controlling material, thereby enabling using the adsorber solid material for interacting with and thus storing therein a predetermined adsorbable gas under desired environmental conditions.

The present structure exhibit excellent water resistance and exhibit a large adsorption and decomposition capacity even when the structure is wet. Thus such structures can be used under severe circumstances of high humidity. The structure of the present invention has an excellent resistance to humidity and does not suffer any deterioration thereby and thus is much more suitable for use under severe conditions.

The invention utilizes the concept of adsorptivity of gas on certain solid materials to provide a gas reserve in a gas storage device. Adsorption is the adhesion of gas molecules to the surfaces of solids by virtue of inter-molecular forces between the gas and the surface of the solid material. All solid materials have a degree of adsorptivity which is dependent upon their molecular and physical structure. Certain materials have sufficient adsorptivity (e.g., about 5% or more by weight of solid at 100 psig and 70° F.) to be useful as storage means for adsorbable gases in pressurized gas storage.

Physical adsorption is generally a readily reversible process, which is pressure dependent. An increase in pressure increases the degree of adsorption. On a subsequent decrease in pressure the adsorbed gas is desorbed along the same isotherm curve.

Solid materials having a sufficient adsorptivity as described are referred to herein as “adsorbing material” and the gases adsorbed to sufficient degree thereon are referred to as “adsorbable gases”. The adsorbable gas in the composition of matter according to the invention is adsorbed onto particulate adsorber material. As used herein the terms “adsorbed”, “fixed”, “affixed” “adhered” or any lingual variation thereof are used interchangeably and refer to accumulation of the adsorbable gas on the surface of the particulate adsorber material. Adsorption may be via physical interaction or via chemical interactions or a combination of the same. The terms “coated” or “covered” or any lingual variation thereof are used interchangeably and refer to a particulate adsorber material onto which adsorbable gas is absorbed. As used in the context of the present invention, the terms “adsorbing”, “adsorbent”, “adsorptive” or “adsorber” materials are used interchangeably.

It should be noted that an effect of adsorption used in the invention covers any type of adsorption of one material composition by the other, including also any physical and/or chemical bonding or interaction between these material compositions. Hence, the expression “adsorber”, “adsorbable gas”, etc. should be interpreted accordingly.

Adsorptive compositions and adsorptive decomposition compositions of the present invention have a large adsorption and desorption rate, and get little degradation in their performances at repeated use.

Suitable adsorbing material may be for example but are not limited to activated carbon, zeolite, organometallic complexes, natural and synthetic zeolite, silica gel, alumina are mentioned. As adsorption material, zeolite is more preferred such as Zeolit grade sx6 from Leiter F&E molekulasiebe. Other suitable adsorbing material for use in this invention include an ethylvinylbenzene-divinylbenzene polymer known by the trademark POROPAK Q and available from Waters Associates, Milford, Mass., crystalline calcium alumino silicate molecular sieve materials such as molecular sieves 4A, 5A and 13X available from Linde Sieves Division, Union Carbide; a diatomaceous earth known by the trademark DIATOMITE and available from Johns-Manville Company, New York, N.Y.; and activated charcoal. As used herein, the terms “activated carbon”, “activated charcoal” and “activated coal” or any lingual variations thereof are interchangeable and refer to a porous carbon with a large surface area for example 500 m²/g and above. In some embodiments the activated carbon is of a surface area of about 1000 m²/g.

Zeolites have generally a porous structure that can accommodate a wide variety of cations, such as Na+, K+, Ca2+, Mg2+ and others. These positive ions are rather loosely held and can readily be exchanged for others in a contact solution. Some of the more common mineral zeolites are analcime, chabazite, clinoptilolite, heulandite, natrolite, phillipsite, and stilbite. The present invention may use natural zeolites as well as synthetic zeolites. There are several types of synthetic zeolites that form by a process of slow crystallization of a silica-alumina gel in the presence of alkalis and organic templates. The synthetics can, of course, be manufactured in a uniform, phase-pure state. It is also possible to manufacture desirable zeolite structures which do not appear in nature.

The zeolite material may also comprise a combination of a plurality of zeolite of different types.

The adsorber solid material may be provided in different forms. The shape in particular may not be limited but it may be arbitrary shape, such as spherical shape including pellet type, a grain type, tabular shape or rod-like shape, moldings, or monoliths, but from points, such as forming cost, a pellet type and a granular thing are more preferred.

In some embodiments, the adsorbent materials have high abrasion resistance, high thermal stability and small pore diameters, which results in higher exposed surface area and hence high surface capacity for adsorption.

In some embodiments, the adsorbent materials are porous material solid increasing the interface of the interaction between the adsorber solid material and the adsorbable gas molecules. The adsorbents may also have a distinct pore structure which enables fast transport of the gaseous vapors.

Suitable adsorbable gases, of course, depend to some extent on the solid material to be used. Natural gas, town gas, air, oxygen, carbon dioxide, hydrogen, carbon oxide, nitrous oxide, nitrogen, helium, argon, neon, krypton, xenon and mixtures thereof, are believed to be acceptable for use in this invention. Nitrogen has been found to be particularly advantageous in this invention because of their high level of adsorption compared with certain other acceptable gases.

In some embodiments, the humidity controlling material is selected for maintaining a predetermined level of humidity. The predetermined level of humidity may be in the range of about 1% to about 5%. The lower limit of the predetermined level of humidity is about 0.01%. The upper limit of the predetermined level of humidity is about 40%.

The humidity controlling material may be a hydrophilic material absorbing the humidity. Alternatively, the humidity controlling material may be a hydrophobic material repelling the humidity such that the adsorber material in interaction with the humidity controlling material is protected from humidity interaction. The hydrophilic/hydrophobic material may be hydrophilic/hydrophobic in nature but may also switch from hydrophilic (hydrophobic) to hydrophobic (hydrophilic) state of the material.

Suitable humidity controlling material may be for example but are not limited to activated carbon, zeolite or a combination of a plurality of zeolite of different types, polymer such as cellulose or ethyl cellulose, polyacrylamide, Cellulose acetate phthalate (CAP), cellulose acetate, polymer based on fluorocarbon PTFE, polytetrafluoroethylene, metal, all types of nylon for example nylon 6,6, silicon, latex, silica gel, alumina.

In some embodiments, the humidity controlling material comprises hygroscopic substances including sugar, honey, glycerol, ethanol, methanol, sulfuric acid, methamphetamine, many salts, and a huge variety of other substances.

The humidity controlling material may be provided in different forms. The shell configuration may be provided in a film form and may comprise at least one selectively permeable (e.g. semi-permeable) barrier/membrane permitting passage of gas therethrough and absorbing humidity. The shell configuration may comprise a plurality of membranes made of different suitable materials. The shell may also be in the form of fibers or sieves coating the cores and separating between the spaced-apart cores.

In some embodiments, at least one of the adsorber solid material and the humidity controlling material is distributed in a predefined three-dimensional spatial arrangement of spaced-apart regions increasing the surface area interface between the storing medium and the adsorbable gas.

In some embodiments, the shell defines a plurality of storage spaces located in between the core regions configured to bind molecules of the adsorbable gas to the core regions. The plurality of storage regions may be distributed in a predefined three-dimensional spatial arrangement of spaced-apart regions increasing the surface area interface between the structure and the adsorbable gas. The spatial arrangement may be selected from at least one layer, a matrix, and a grid. The structure may comprise a plurality of cores embedded in at least one shell having a matrix configuration. The core has a predefined shape selected from spherical shape or elongated shape.

In some embodiments, the adsorber solid material is coated with the humidity controlling material thereby providing the interaction between the humidity controlling material and the adsorber solid material. The adsorber solid material may be encapsulated by the humidity controlling material.

The adsorber solid material may be in the form of spaced-apart pellet, each pellet being coated by a humidity controlling material. Alternatively, a plurality of pellets may be coated by the same humidity controlling material.

This invention includes a number of unique systems for the efficient utilization of the adsorption phenomenon. There is also provided a pressure vessel for use in storing at least one gas. The pressure vessel comprises an entrance/exit opening for allowing entrance or exit therethrough of at least one adsorbable gas to be stored at a pressurized state; a cavity coupled to the entrance/exit opening and configured for feeding and containing therein a storing medium, the storing medium comprising: an adsorber solid material selected to adsorb adsorbable molecules of the at least one gas; and a humidity controlling material being selected for maintaining a predetermined level of humidity in the cavity.

The pressure in the pressure vessel being significantly above atmospheric pressure, after the pressure vessel has been opened (for example through a valve), the pressure in the interior of the pressure vessel decreases, and the gas flows out. When the pressure in the container is decreased, the gas is released being ejected/expel from the gas storage device. When the pressure in the pressure vessel is reduced, adsorbed gas is freed from adsorption on the surface of the solid. Thus, such adsorbing material can provide a gas reserve. The use of the adsorbing material shows high storage performance which is several times the storage performance of conventional gas storage devices per same geometric volume.

The invention may be used with any pressure vessel referred also as a gas tank, gas receiver, gas storage device, pressurized package or container-dispenser. The pressure vessel is a closed container designed to hold gases or liquids at a pressure substantially different from the ambient pressure. It could be a receiver attached to a compressor or it could be a bottle full of gas or any device that is intended to store the gas or the compressed gas. Gas receivers are strong containers with all kind of shapes and are manufactured from all kind of material so they can hold the compressed gas. These containers are usually hollow such that the gas may be pushed therein and stored.

Pressure vessels may theoretically be almost any shape, but shapes made of sections of spheres, cylinders, and cones are usually employed. The shape of the gas storage device may not be limited but may be arbitrary state such as a cylindrical shaped pipe shape, a cube, a rectangular parallelepiped, an ellipse. A common design is a cylinder with hemispherical end caps called heads. More complicated shapes have historically been much harder to analyze for safe operation and are usually far more difficult to construct. Several gas storage devices having or not a different geometrical shape may be feed by the same conduit.

Generally, almost any material with good tensile properties that is chemically stable in the chosen application can be employed for manufacturing the cavity of the present vessel. Many pressure vessels are made of steel. Pressure vessels are designed to operate safely at a specific pressure and temperature.

In some embodiments, the humidity controller material is in interaction with the adsorber solid material.

In some embodiments, the storing medium has a core-shell configuration.

In some embodiments, the pressure vessel is a low-pressure vessel. The cavity is configured to contain gas in a low-pressure zone at a pressure significantly above atmospheric pressure. The cavity may comprise a composite shell made of at least one of the adsorber solid material and the humidity controlling material.

In some embodiments, the pressure vessel is characterized by an increased amount of gas stored per a given volume of the cavity, due to the adsorption of the adsorbable gas molecules by the storing medium. The amount of gas to be stored is much more than would be without the presence of an adsorbing material under the same pressure/temperature conditions. The present invention enables to decrease a pressure exerted on a gas per a given storage quantity and volume by interacting between at least one adsorbing material and at least one adsorbable gas and storing the feed adsorbable gas in a pressurized state in a gas storage device.

In some embodiments, the pressure vessel is characterized by a decreases pressure of gas stored per a given quantity of gas to be stored and per a given volume of the cavity, due to the adsorption of the adsorbable gas molecules by the storing medium.

In some embodiments, the pressure vessel is configured for supplying the gas by decreasing the pressure in the pressure vessel.

In some embodiments, the pressure vessel comprises a valve located at the entrance/exit opening configured for inserting the gas and thereafter supplying the gas.

The storing medium to be fed into the cavity may comprise the adsorbable gas adsorbed by the adsorber material.

In some embodiments, the adsorbing material and the pressurized adsorbable gas are mixed before being introduced into a gas storage device.

In some embodiments, the cavity is separated in a plurality of chambers, each chamber containing at least one of the adsorber solid material and the humidity controlling material.

In some embodiments, the entrance/exit opening comprises a filter for filtering therethrough at least one adsorbable gas.

According to another broad aspect of the present invention, there is also provided a device for use in storing at least one gas, the device comprising a cavity configured for containing therein a storing medium and comprising an outlet for coupling and transferring the storing medium into a gas storage pressure vessel, the storing medium comprising an adsorber solid material selected to adsorb adsorbable molecules of the at least one gas; and a humidity controlling material in interaction with the adsorber solid material, the humidity controlling material being selected for maintaining a predetermined level of humidity in the cavity.

According to another broad aspect of the present invention, there is also provided a conduit/extension to be connected with at least one pressure vessel, the conduit forming a passageway for at least one adsorbable gas to be stored in the pressure vessel, the passageway containing a storing medium comprising an adsorber solid material configured to selectively adsorb adsorbable gas molecules and a humidity controlling material interacted with the adsorber solid material to maintain a predetermined level of humidity in the pressure vessel.

The conduit may be associated with at least one of the gas inlet and outlet of the pressure vessel.

In some embodiments, the adsorbing material and the pressurized adsorbable gas are placed in interaction through the conduit containing the adsorbing material before being introduced into the pressure vessel.

In some embodiments, the gas is stored by a gas machine under application of pressure by a compressor through the conduit containing the adsorbing material adsorbing at least a part of the adsorbable gas.

In some embodiments, the conduit containing the adsorbing material is a conduit made of a metal material (e.g. stainless still, aluminum) and coated with the storing medium.

In some embodiments, the conduit containing the adsorbing material is a conduit made of a metal material and coated with at least one of the adsorber material and the humidity controller material.

In some embodiments, the conduit comprises a composite shell made of at least one of the adsorber solid material and the humidity controller material.

In some embodiments, the conduit comprises a filter for filtering therethrough at least one adsorbable gas.

According to another broad aspect of the present invention, there is also provided a method for storing a gas by adsorbing the gas by an adsorber solid material coated with a humidity controlling material.

The method comprises encapsulating or embedding the adsorber solid material with humidity controlling material.

According to another broad aspect of the present invention, there is provided a composition of matter for use in storing a gas. The composition comprises a predetermined adsorber solid material, and a predetermined humidity controlling material at least partially surrounding the adsorber solid material, thereby enabling using the adsorber solid material for interacting with and thus storing therein a predetermined adsorbable gas under desired environmental conditions.

In some embodiments, the composition comprises a plurality of adsorber solid material regions is distributed in a predefined three-dimensional spatial arrangement of spaced-apart regions increasing the surface area interface between the composition and the adsorbable gas.

In some embodiments, the composition comprises a plurality of humidity controller material embedded in at least one adsorber solid material having a matrix configuration.

### BRIEF DESCRIPTION OF THE DRAWINGS

In order to understand the invention and to see how it may be carried out in practice, embodiments will now be described, by way of non-limiting example only, with reference to the accompanying drawings, in which:

FIGS. 1A-C are schematic illustrations of the structure of the present invention having a core-shell configuration;

FIGS. 2A-D are schematic illustrations of a pressure vessel according to the teachings of the present invention as compared to conventional pressure vessels (FIGS. 2A, 2C);

FIGS. 3A-3F are schematic illustrations of examples of a possible configuration of the pressure vessel of the present invention;

FIGS. 4A-4C are schematic illustrations of examples of a conduit to be connected with a pressure vessel; and;

FIGS. 5A-5F are schematic illustrations of examples of a possible configuration of the pressure vessel of the present invention.

### DETAILED DESCRIPTION OF EMBODIMENTS

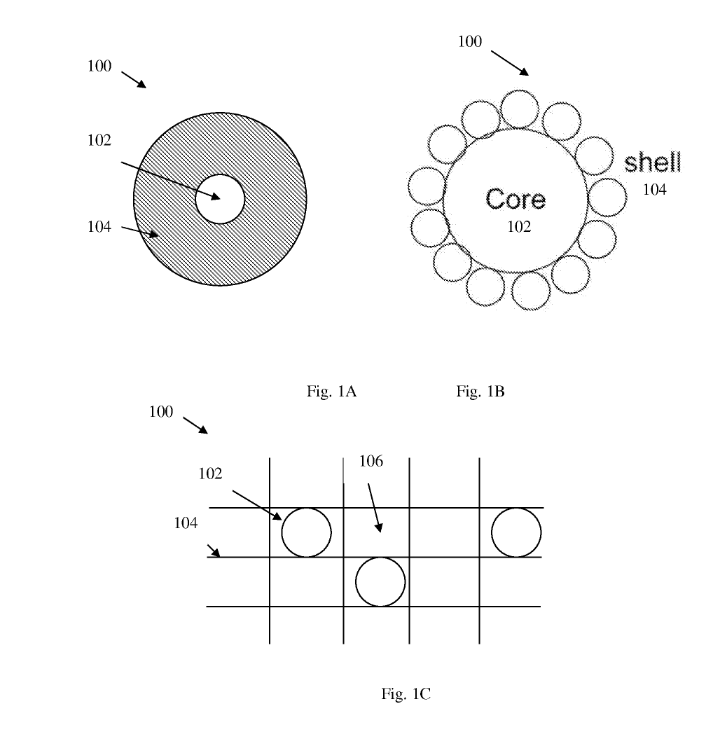

Reference is made to FIGS. 1A-1C representing the structure 100 of the present invention having a core-shell configuration. The core 102 comprises a predetermined adsorber solid material, and the shell at least partially surrounding 104 the core comprises a predetermined humidity controlling material. The adsorber solid material is thus for interacting with an adsorbable gas and storing therein the gas. The core-shell configuration may comprise a core of an adsorber solid material surrounded by one or more shells of a humidity controlling material. The humidity controlling material protects the adsorber solid material from humidity, optimizing the properties of the adsorber solid material. The shell 104 may be continuous as illustrated in FIG. 1A or discontinuous as illustrated in FIG. 1B. The shell 104 may be a selectively permeable membrane permitting passage of the adsorbable gas therethrough. The shell may also be in the form of a carrier carrying the adsorber solid material. The adsorber solid material may be therefore coated with the humidity controlling material. As illustrated in FIG. 1A, the adsorber solid material may be encapsulated by the humidity controlling material.

As illustrated in FIG. 1C, the shell 104 may define a plurality of storage spaces 106 located in between the core regions 102 configured to bind molecules of the adsorbable gas to the core regions. The plurality of core regions 102 is distributed in a predefined three-dimensional spatial arrangement of spaced-apart regions increasing the surface area interface between the structure and the adsorbable gas. In this specific and non-limiting example, the structure 100 comprises a plurality of cores 102 embedded in a shell 104 having a matrix configuration.

Although not shown, the core 102 may have distinct arbitrary shapes including spherical shape or elongated shape. The core 102 may also comprise a plurality of discrete entities forming the adsorber solid material. The core 102 may also be embedded in a matrix of shell.

Reference is made to FIGS. 2B and 2D illustrating a pressure vessel 200 according to the teachings of the present invention. FIGS. 2A and 2C represents conventional pressure vessel for the sake of comparison. The pressure vessel 200 is to be used in storing at least one gas 202. The pressure vessel 200 comprises an entrance/exit opening 206 for allowing entrance or exit therethrough of at least one adsorbable gas 202 to be stored at a pressurized state; a cavity 204 coupled to the entrance/exit opening 206 and configured for feeding and containing therein a storing medium 208. The storing medium 208 comprising an adsorber solid material selected to adsorb adsorbable molecules of the at least one gas; and a humidity controlling material in interaction with the adsorber solid material. The humidity controlling material is selected for maintaining a predetermined level of humidity in the cavity 204. The storing medium 208 may be dispersed in the cavity 204 before or after feeding the adsorbable gas 202. The storing medium 208 may comprise the adsorbable gas mixed with the adsorber material.

By using the teachings of the present invention, the pressure vessel 200 enables to feed an increased amount of gas stored per a given volume of the cavity 204 (as compared to conventional pressure vessel illustrated in FIG. 2A having an amount of gas) due to the adsorption of the adsorbable gas molecules 202 by the storing medium 208.

The inventors have performed some experiments using a gas container having a volume of 2 liter to be feed with nitrogen. The gas container was filled with an adsorbing material (randomly dispersed) until a maximal height of about 20 cm keeping the low humidity conditions (less than 1%) and then a certain amount of nitrogen was inserted until a pneumatic pressure of 7 bars was raised and measured in ccN/sec.

In a first experiment performed without using a storing medium, the volume of inserted nitrogen was 9976 ccn. Thereafter, the gas container was filled with the storing medium and the volume of inserted nitrogen was 23681 ccn.

In a second experiment performed without using a storing medium, the volume of inserted nitrogen was 10710 ccn. Thereafter, the gas container was filled with the storing medium and the volume of inserted nitrogen was 24566 ccn.

The experiment was reproduced several times. The averaged results are such that when the gas container was filled with the storing medium, the averaged volumetric of nitrogen entering into the gas container was 24099 ccn while without the storing medium, the averaged volume of inserted nitrogen was 10343 ccn. Therefore, the volume of nitrogen entering the gas container with the presence of a storing medium was 2.33 higher than without the storing medium.

Another experiment was performed with a pneumatic pressure of 9 bars. In a first experiment performed without using a storing medium, the volume of inserted nitrogen was 12400 ccn. Thereafter, the gas container was filled with the storing medium (randomly dispersed), the volume of inserted nitrogen was 33000 ccn.

In a second experiment performed without using a storing medium, the volume of inserted nitrogen was 12300 ccn. Thereafter, the gas container was filled with the storing medium and then, thus the volume of inserted nitrogen was 31000 ccn the time of the experiment was 65 sec.

The experiment was reproduced several times. The averaged results are such that when the gas container was filled with the storing medium, the averaged volumetric of nitrogen entering into the gas container was 31200 ccn while without the storing medium, the averaged volume of inserted nitrogen was 12350 ccn. Therefore, the volume of nitrogen entering the gas container with the presence of an adsorbing material was 2.53 higher than without the storing medium.

Moreover, by using the teachings of the present invention, the pressure vessel 200 enables to feed a given amount of gas by decreasing the pressure of gas stored per a given quantity of gas and per a given volume of the cavity, due to the adsorption of the adsorbable gas molecules by the storing medium as illustrated in FIGS. 2C-2D.

Instead of using a high pressure vessel has commonly used in this field, the pressure vessel of the present invention may be a low-pressure vessel. The cavity is configured to contain gas in a low-pressure zone at a pressure significantly above atmospheric pressure. For the same given amount of gas stored in the pressure vessel, the technique of the present invention enables to save energy usually used to compress the gas into the pressure vessel to reach a high pressure level. Such high pressure constraints are generally associated with a large amount of gas to be stored in a small vessel volume.

The pressure vessel 200 supplies the adsorbed gas 202 when the pressure in the pressure vessel is decreased. To this end, the pressure vessel may comprise a valve located at the entrance/exit opening configured for inserting the gas and thereafter supplying the gas.

The cavity 204 may comprise a composite shell made of the adsorber solid material and/or of the humidity controlling material.

The selection of humidity controlling material may be performed as follows: for a pressure vessel operable at a pressure of 200 atm, 8 cubes of nitrogen can be fed corresponding to 183 Kg of nitrogen. 1 gr of adsorber material (KÖSTROLITH SX6K) at 25° C. having a density of about 20 gr/ml adsorbs 40 cc of adsorbable gas. The inventors have performed some experiments in which the adsorption material was arranged in a grid configuration (increasing the contact surface area between the adsorption material and the adsorbable material) in a pressure vessel of 2 liters, at a pressure of 9 bars. The adsorption was about 5 times as compared with a pressure vessel without any adsorption material. Therefore, the internal arrangement of the adsorption material within the vessel provides a better adsorption as compared to the randomly dispersion of the storing medium within the vessel.

Moreover, the inventors have performed an experiment with the storing medium of the present invention including the humidity controller material, in a pressure vessel of 2 liters, at a pressure of 9 bars and a temperature of 25° C., the adsorption was 10 times as compared with a pressure vessel without any adsorption material.

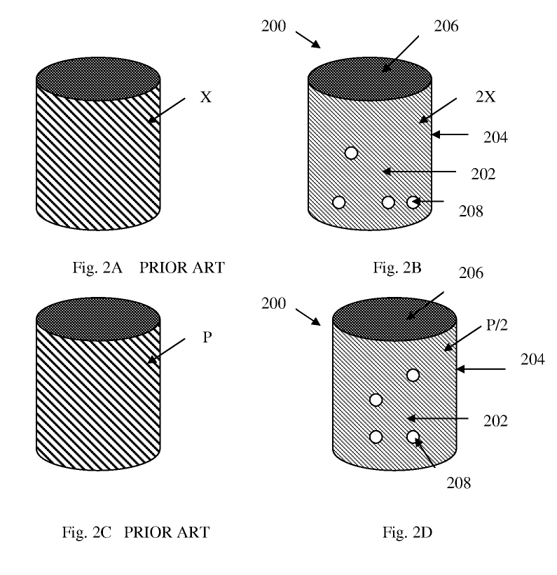

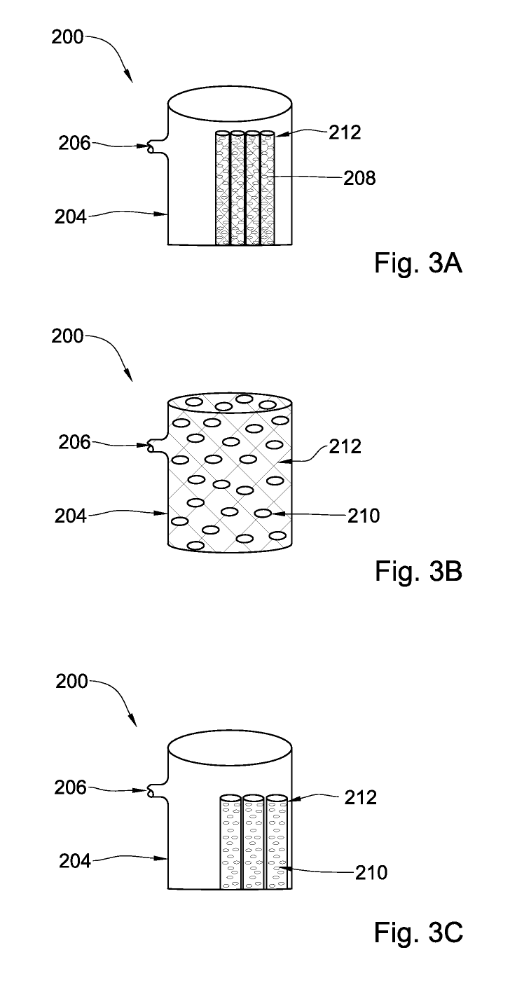

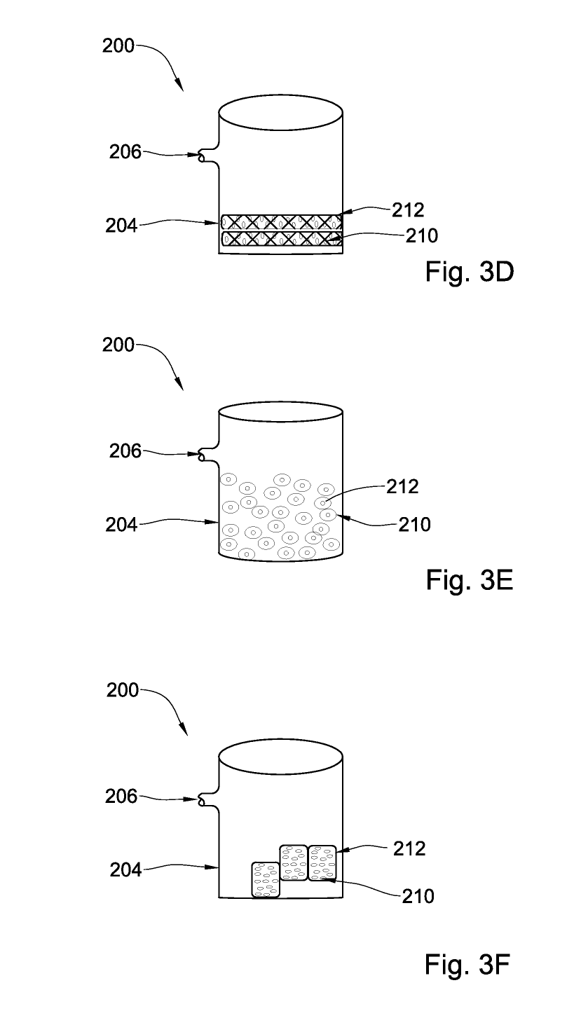

Reference is made to FIG. 3A illustrating an example of a possible configuration of the pressure vessel 200 of the present invention. The pressure vessel 200 comprises an entrance/exit opening (gas inlet/outlet) 206 for allowing entrance or exit therethrough of at least one adsorbable gas to be stored at a pressurized state; a cavity 204 coupled to the entrance/exit opening 206 and configured for feeding and containing therein a storing medium 208. The storing medium 208 comprises the adsorber solid material represented by the small spaced-apart pellets embedded in a humidity controlling material being in the form of a plurality of adjacent rods 212 (e.g. tubes) arranged inside the cavity 204. The rods 212 may have an internal grid pattern configured for accommodating separately each spaced-apart pellet and for permitting the passage of the adsorbable gas. This configuration enables an increased surface area of contact between the adsorbable gas and the adsorber material.

The size of the pellets is arbitrary. For example, the adsorber solid material may have a diameter in the range of about 1.2-2 mm. In another example, the adsorber solid material may have a diameter in the range of about 1.6-3.2 mm.

Reference is made to FIG. 3B illustrating another example of a possible configuration of the pressure vessel 200 of the present invention. The pressure vessel 200 comprises an entrance/exit opening (gas inlet/outlet) 206 for allowing entrance or exit therethrough of at least one adsorbable gas to be stored at a pressurized state; a cavity 204 coupled to the entrance/exit opening 206 and configured for feeding and containing therein a storing medium. The storing medium comprises the adsorber solid material represented by the spaced-apart pellets 210 embedded in a humidity controlling material being in the form of a grid 212 filling the entire cavity 204.

Reference is made to FIG. 3C illustrating another example of a possible configuration of the pressure vessel 200 of the present invention. The pressure vessel 200 comprises an entrance/exit opening (gas inlet/outlet) 206 for allowing entrance or exit therethrough of at least one adsorbable gas to be stored at a pressurized state; a cavity 204 coupled to the entrance/exit opening 206 and configured for feeding and containing therein a storing medium. The storing medium comprises the adsorber solid material represented by the spaced-apart pellets 210 embedded in a humidity controlling material being in the form of tubes 212 partially filling the cavity 204.

Reference is made to FIG. 3D illustrating another example of a possible configuration of the pressure vessel 200 of the present invention. The pressure vessel 200 comprises an entrance/exit opening (gas inlet/outlet) 206 for allowing entrance or exit therethrough of at least one adsorbable gas to be stored at a pressurized state; a cavity 204 coupled to the entrance/exit opening 206 and configured for feeding and containing therein a storing medium. The storing medium comprises the adsorber solid material represented by the spaced-apart pellets 210 embedded in a humidity controlling material being in the form of layers/plates 212 partially filling the cavity 204.

Reference is made to FIG. 3E illustrating another example of a possible configuration of the pressure vessel 200 of the present invention. The pressure vessel 200 comprises an entrance/exit opening (gas inlet/outlet) 206 for allowing entrance or exit therethrough of at least one adsorbable gas to be stored at a pressurized state; a cavity 204 coupled to the entrance/exit opening 206 and configured for feeding and containing therein a storing medium. The storing medium has a core-shell configuration partially and randomly dispersed in the cavity 204. The adsorber solid material represented by the spaced-apart pellets 210 are the cores coated by the shells 212. In this specific and non-limiting example, each core has its own shell i.e. each pellet is coated by a humidity controlling material.

Reference is made to FIG. 3F illustrating another example of a possible configuration of the pressure vessel 200 of the present invention. The pressure vessel 200 comprises an entrance/exit opening (gas inlet/outlet) 206 for allowing entrance or exit therethrough of at least one adsorbable gas to be stored at a pressurized state; a cavity 204 coupled to the entrance/exit opening 206 and configured for feeding and containing therein a storing medium. The storing medium has a core-shell configuration. The storing medium comprises a plurality of shells 212 partially filling the cavity 204. The adsorber solid material represented by the spaced-apart pellets 210 are the cores embedded in the shells 212. In this specific and non-limiting example, a plurality of cores is surrounded by the same shell i.e. a group of pellets is coated by the same humidity controlling material. The shell may be in the form of fibers or sieves coating the cores.

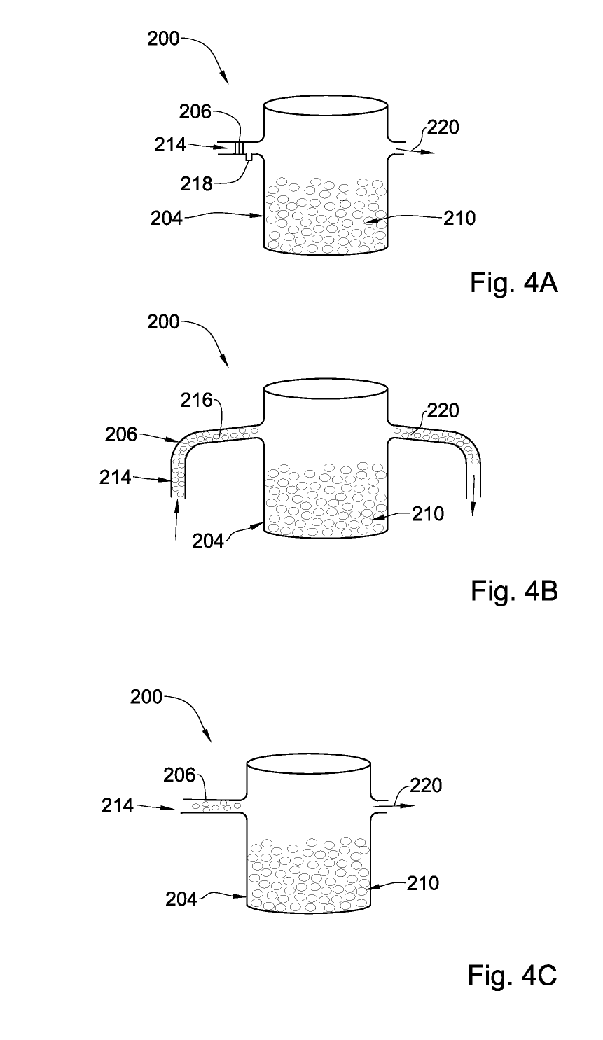

Reference is made to FIG. 4A illustrating another example of a possible configuration of the pressure vessel 200 of the present invention. The pressure vessel 200 comprises an entrance opening (gas inlet) 206 for allowing entrance therethrough of at least one adsorbable gas to be stored at a pressurized state; a cavity 204 coupled to the entrance/exit opening 206 and configured for feeding and containing therein a storing medium. The pressure vessel is connected to a conduit 214 forming a passageway for at least one adsorbable gas to be stored in the pressure vessel. The passageway contains a storing medium comprising an adsorber solid material configured to selectively adsorb adsorbable gas molecules and a humidity controlling material interacted with the adsorber solid material to maintain a predetermined level of humidity in the pressure vessel. In this specific and non-limiting example, the conduit 214 accommodates a humidity controlling material (e.g. polymeric/zeolite membrane/film) and has an opening 218 for allowing exit therethrough of humidity (water). The adsorber solid material is represented by the spaced-apart pellets 210. In this configuration, the gas inlet and outlet are separated. The adsorbable gas is supplied by the gas outlet 220.

Alternatively, the conduit 214 may comprise a composite shell made of the adsorber solid material.

In some embodiments, the conduit 214 may comprise a filter material operable to filter the adsorbable gas material from waste and to introduce inside the cavity 204 almost pure (from 95% and above) adsorbable gas material. Such filter material may be any suitable polymer.

Reference is made to FIG. 4B illustrating another example of a possible configuration of the pressure vessel 200 of the present invention. The pressure vessel 200 comprises an entrance opening (gas inlet) 206 for allowing entrance therethrough of at least one adsorbable gas to be stored at a pressurized state; a cavity 204 coupled to the entrance/exit opening 206 and configured for feeding and containing therein a storing medium. The pressure vessel is connected to a conduit 214 forming a passageway for at least one adsorbable gas to be stored in the pressure vessel. The passageway contains a storing medium comprising an adsorber solid material configured to selectively adsorb adsorbable gas molecules and a humidity controlling material interacted with the adsorber solid material to maintain a predetermined level of humidity in the pressure vessel. In this specific and non-limiting example, the conduit 214 accommodates a humidity controlling material 216 in a core-shell configuration in which a plurality of spaced-apart cores (adsorbed solid material) 210 embedded (e.g. coated) in a shell (humidity controlling material) having a matrix configuration. The pressure vessel also comprises a plurality of spaced-apart adsorbed solid material 210. In this configuration, the gas inlet and outlet are separated. The adsorbable gas is supplied by the gas outlet 220. In this specific and non-limiting example, the gas outlet 220 also accommodates a plurality of spaced-apart adsorbed solid material 210 increasing the efficiency of the adsorption.

Reference is made to FIG. 4C illustrating another example of a possible configuration of the pressure vessel 200 of the present invention. The pressure vessel 200 comprises an entrance opening (gas inlet) 206 for allowing entrance therethrough of at least one adsorbable gas to be stored at a pressurized state; a cavity 204 coupled to the entrance/exit opening 206 and configured for feeding and containing therein a storing medium. The pressure vessel is connected to a conduit 214 forming a passageway for at least one adsorbable gas to be stored in the pressure vessel. The passageway contains a storing medium comprising an adsorber solid material configured to selectively adsorb adsorbable gas molecules and a humidity controlling material interacted with the adsorber solid material to maintain a predetermined level of humidity in the pressure vessel. In this specific and non-limiting example, the conduit 214 accommodates a humidity controlling material in which a plurality of spaced-apart cores (adsorbed solid material) 210 are coated by a humidity controlling material. The pressure vessel also comprises a plurality of spaced-apart adsorbed solid material 210. In this configuration, the gas inlet and outlet are separated. The adsorbable gas is supplied by the gas outlet 220.

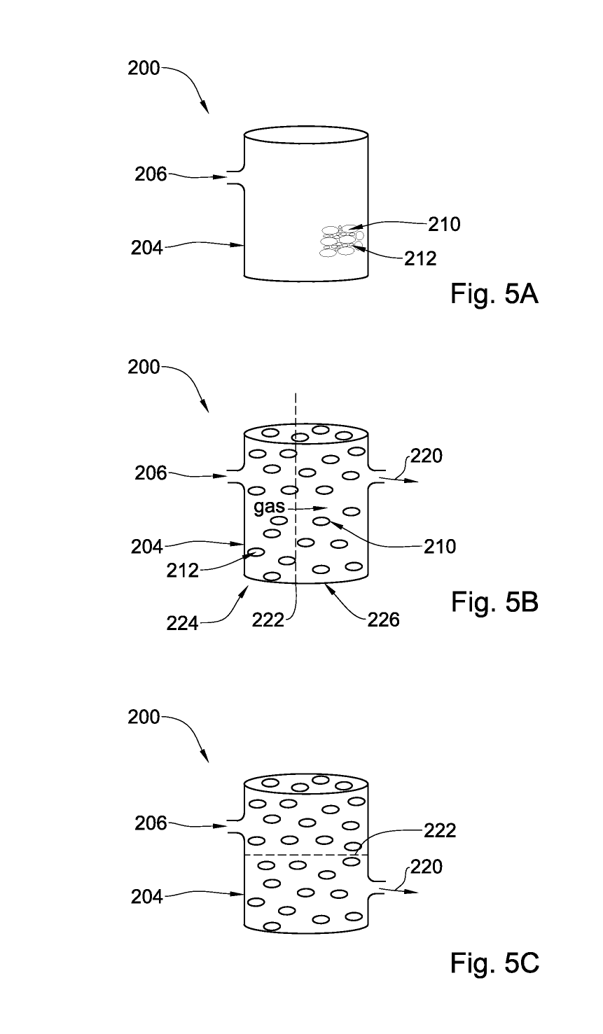

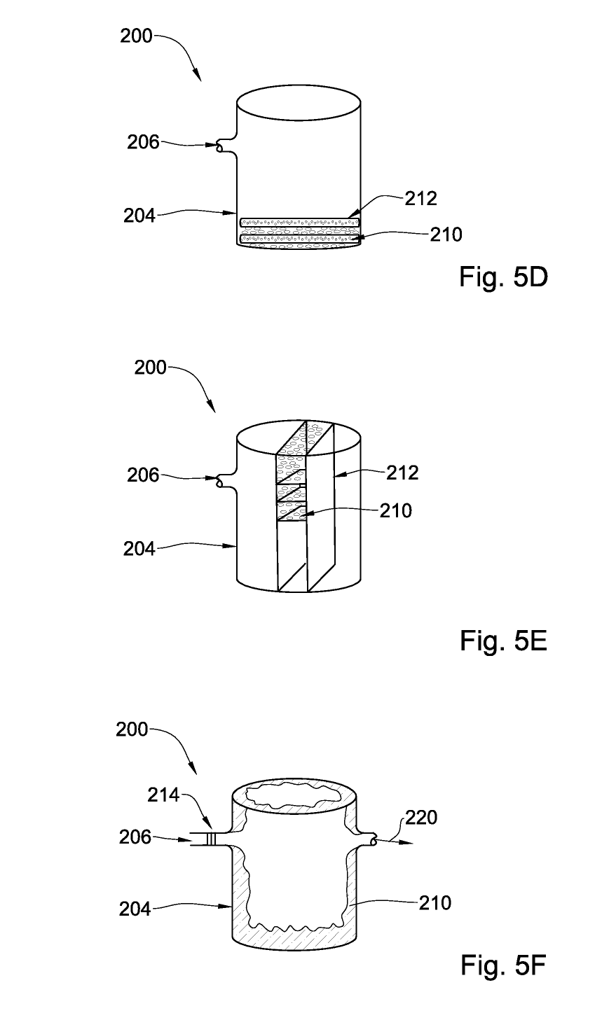

Reference is made to FIG. 5A illustrating another example of a possible configuration of the pressure vessel 200 of the present invention. The pressure vessel 200 comprises an entrance/exit opening (gas inlet/outlet) 206 for allowing entrance or exit therethrough of at least one adsorbable gas to be stored at a pressurized state; a cavity 204 coupled to the entrance/exit opening 206 and configured for feeding and containing therein a storing medium. The storing medium has a core-shell configuration. The storing medium comprises an arrangement of a plurality of spaced-apart adsorber solid material 210 and a humidity controlling material 212 partially filling the cavity 204. In this specific and non-limiting example, the humidity controlling material 212 fills the spaces between the spaced-apart adsorber solid materials 210.

Reference is made to FIG. 5B illustrating another example of a possible configuration of the pressure vessel 200 of the present invention. The pressure vessel 200 comprises an entrance opening (gas inlet) 206 for allowing entrance therethrough of at least one adsorbable gas to be stored at a pressurized state; a cavity 204 coupled to the entrance/exit opening 206 and configured for feeding and containing therein a storing medium. In this configuration, the gas inlet and outlet are separated. The adsorbable gas is supplied by the gas outlet 220. The cavity 204 contains a separation means 222 separating the cavity 204 in two chambers 224 and 226. The separation means 220 (e.g. selectively permeable membrane) permits gas flow from one chamber 224 to the other 226. One chamber 224 contains the humidity controlling material 212 and the other chamber 226 contains the adsorber solid materials 210. The humidity controlling materials 212 as well as the adsorber solid materials 210 are in form of spaced-apart pellets randomly dispersed in the chamber 224 and 226 respectively.

Reference is made to FIG. 5C illustrating another example of a possible configuration of the pressure vessel 200 of the present invention. This configuration is similar to the configuration of FIG. 5B. The separation means 222 is horizontal (instead of vertical in FIG. 5B) and therefore the gas inlet 206 and outlet 220 are disposed in on both sides of the separation means 222.

Reference is made to FIG. 5D illustrating another example of a possible configuration of the pressure vessel 200 of the present invention. The pressure vessel 200 comprises an entrance/exit opening (gas inlet/outlet) 206 for allowing entrance or exit therethrough of at least one adsorbable gas to be stored at a pressurized state; a cavity 204 coupled to the entrance/exit opening 206 and configured for feeding and containing therein a storing medium. The storing medium comprises an arrangement of a plurality of spaced-apart adsorber solid material 210 and a humidity controlling material 212 partially filling the cavity 204. In this specific and non-limiting example, the adsorber solid material 210 is in the form of layers, the humidity controlling materials 212 being in the form of spaced-apart pellets randomly dispersed between the layers 210.

Reference is made to FIG. 5E illustrating another example of a possible configuration of the pressure vessel 200 of the present invention. The pressure vessel 200 comprises an entrance/exit opening (gas inlet/outlet) 206 for allowing entrance or exit therethrough of at least one adsorbable gas to be stored at a pressurized state; a cavity 204 coupled to the entrance/exit opening 206 and configured for feeding and containing therein a storing medium. In this specific and non-limiting example, the storing medium is in a core-shell configuration. The humidity controlling material 212 is in the form of a separation grid defining spaces in which a plurality of spaced-apart adsorber solid material 210 is accommodated.

Reference is made to FIG. 5F illustrating another example of a possible configuration of the pressure vessel 200 of the present invention. The pressure vessel 200 comprises an entrance opening (gas inlet) 206 for allowing entrance therethrough of at least one adsorbable gas to be stored at a pressurized state; a cavity 204 coupled to the entrance/exit opening 206 and configured for feeding and containing therein a storing medium. The pressure vessel is connected to a conduit 214 forming a passageway for at least one adsorbable gas to be stored in the pressure vessel. The passageway contains a humidity controlling material maintaining a predetermined level of humidity in the pressure vessel. In this specific and non-limiting example, the conduit 214 accommodates a humidity controlling material (e.g. polymeric/zeolite membrane/film). In this configuration, the gas inlet and outlet are separated. The adsorbable gas is supplied by the gas outlet 220. In this configuration, the cavity 204 is at least partially made of a gas adsorption material 210 or is at least partially coated with a gas adsorption material 210. In some embodiments, the cavity 204 may be at least partially made of a humidity controlling material or is at least partially coated with a humidity controlling material.

In some embodiments, the gas outlet 220 may also comprise an adsorber solid material.

1. A structure having a core-shell configuration, the core comprising a predetermined adsorber solid material, and the shell at least partially surrounding said core comprising a predetermined humidity controlling material, thereby enabling using said adsorber solid material for interacting with and thus storing therein a predetermined adsorbable gas under desired environmental conditions.

2. The structure of claim 1, wherein said humidity controlling material is selected for maintaining a predetermined level of humidity.

3. The structure of claim 2, wherein the upper limit of said predetermined level of humidity is about 40%.

4. The structure of claim 1, wherein said adsorber solid material is selected from activated carbon, zeolite organometallic complexes, silica gel, alumina, polymers or any combination thereof.

5. The structure of claim 1, wherein said adsorber solid material is a porous material increasing the interface of the interaction between said adsorber solid material and said adsorbable gas molecules.

6. The structure of claim 1, wherein said shell is a selectively permeable membrane permitting passage of the adsorbable gas therethrough.

7. The structure of claim 1, wherein said shell defines a plurality of storage spaces located in between the core regions configured to bind molecules of the adsorbable gas to the core regions.

8. The structure of claim 7, wherein said plurality of core regions is distributed in a predefined three-dimensional spatial arrangement of spaced-apart regions increasing the surface area interface between said structure and said adsorbable gas.

9. The structure of claim 8, wherein said spatial arrangement is selected from at least one layer, a matrix, and a grid.

10. The structure of claim 1, comprises a plurality of cores embedded in at least one shell having a matrix configuration.

11. The structure of claim 1, wherein said core has a predefined shape selected from spherical shape or elongated shape.

12. The structure of claim 1, wherein said humidity controlling material is selected from activated carbon, zeolite polymer silicon, latex, a metal, silica gel and alumina or any combination thereof.

13. The structure of claim 1, wherein said adsorber solid material is coated with said humidity controlling material.

14. The structure of claim 13, wherein said adsorber solid material is encapsulated by said humidity controlling material.

15. A pressure vessel for use in storing at least one gas comprising:
an entrance/exit opening for allowing entrance or exit therethrough of at least one adsorbable gas to be stored at a pressurized state;
a cavity coupled to said entrance/exit opening and configured for feeding and containing therein a storing medium, said storing medium comprising:
an adsorber solid material selected to adsorb adsorbable molecules of said at least one gas; and
a humidity controlling material being selected for maintaining a predetermined level of humidity in said cavity.

16. The pressure vessel of claim 15, wherein said adsorbable gas is selected from natural gas, town gas, air, oxygen, carbon dioxide, carbon oxide, nitrous oxide, nitrogen, helium, argon, neon, krypton, xenon, hydrogen, and mixtures thereof.

17. The pressure vessel of claim 15, wherein said adsorber solid material is selected from activated carbon, zeolite organometallic complexes, silica gel, alumina, polymers or any combination thereof.

18. The pressure vessel of claim 15, wherein said adsorber solid material is a porous material increasing the interface of interaction between said adsorber solid material and said adsorbable gas molecules.

19. The pressure vessel of claim 15, wherein said humidity controlling material is in interaction with said adsorber solid material.

20. The pressure vessel of claim 19, wherein said storing medium has a core-shell configuration.

21. The pressure vessel of claim 20, wherein said shell defines a plurality of storage spaces located in between the core regions configured to bind molecules of the adsorbable gas to the core regions.

22. The pressure vessel of claim 15, wherein at least one of said an adsorber solid material and said humidity controlling material is distributed in a predefined three-dimensional spatial arrangement of spaced-apart regions increasing the surface area interface between said storing medium and said adsorbable gas.

23. The pressure vessel of claim 22, wherein said spatial arrangement is selected from at least one layer, a matrix, and a grid.

24. The pressure vessel of claim 20, wherein said core-shell configuration comprises a plurality of cores embedded in a shell having a matrix configuration.

25. The pressure vessel of claim 20, wherein said core defines storage regions of a predefined shape selected from spherical shape or elongated shape.

26. The pressure vessel of claim 15, wherein said humidity controlling material is selected from activated carbon, zeolite, polymer silicon, latex, metal, silica gel, alumina or any combination thereof.

27. The pressure vessel of claim 15, wherein the upper limit of said predetermined level of humidity is about 40%.

28. The pressure vessel of claim 15, wherein said humidity controlling material is a selectively permeable membrane permitting passage of the adsorbable gas therethrough.

29. The pressure vessel of claim 15, being a low-pressure vessel, said cavity being configured to contain gas in a low-pressure zone at a pressure significantly above atmospheric pressure.

30. The pressure vessel of claim 15, wherein said cavity comprises a composite shell made of at least one of said adsorber solid material and said humidity controlling material.

31. The pressure vessel of claim 19, wherein said adsorber solid material is coated with the humidity controlling material thereby providing said interaction between the humidity controlling material and the adsorber solid material.

32. The pressure vessel of claim 31, wherein said coating of said adsorber solid material with humidity controlling material comprises encapsulating said adsorber solid material with humidity controlling material.

33. The pressure vessel of claim 15, characterized by an increased amount of gas stored per a given volume of the cavity, due to said adsorption of the adsorbable gas molecules by the storing medium.

34. The pressure vessel of claim 15, characterized by a decreases pressure of gas stored per a given quantity of gas to be stored and per a given volume of the cavity, due to the adsorption of the adsorbable gas molecules by said storing medium.

35. The pressure vessel of claim 15, configured for supplying said gas by decreasing the pressure in said pressure vessel.

36. The pressure vessel of claim 15, comprising a valve located at said entrance/exit opening configured for inserting said gas and thereafter supplying said gas.

37. The pressure vessel of claim 15, wherein the storing medium to be fed into said cavity comprises said adsorbable gas adsorbed by said adsorber material.

38. The pressure vessel of claim 15, wherein said storing medium to be fed into said cavity comprises said adsorbable gas mixed with said adsorber material.

39. The pressure vessel of claim 15, wherein said cavity is separated in a plurality of chambers, each chamber containing at least one of said adsorber solid material and said humidity controlling material.

40. The pressure vessel of claim 15, wherein said entrance/exit opening comprises a filter for filtering therethrough at least one adsorbable gas.

41. A conduit to be connected with at least one pressure vessel, said conduit forming a passageway for at least one adsorbable gas to be stored in said pressure vessel, said passageway containing a storing medium comprising at least one of an adsorber solid material configured to selectively adsorb adsorbable gas molecules and a humidity controlling material interacted with said adsorber solid material to maintain a predetermined level of humidity in the pressure vessel.

42. A method for storing a gas by adsorbing said gas by an adsorber solid material coated with a humidity controlling material.

43. The method of claim 42, wherein said gas is selected from natural gas, town gas, air, oxygen, carbon dioxide, nitrous oxide, carbon oxide, hydrogen, nitrogen, helium, argon, neon, krypton, xenon and mixtures thereof.

44. The method of claim 42, wherein said adsorber solid material is selected from activated carbon, zeolite, organometallic complexes, polymers, silica gel, alumina or any combination thereof.

45. The method of claim 42, wherein said humidity controlling material is selected from activated carbon, zeolite, polymer, silicon, latex, metal, silica gel, alumina or any combination thereof.

46. The method of claim 42, comprising encapsulating or embedding said adsorber solid material with humidity controlling material.

47. A composition of matter for use in storing a gas comprising a predetermined adsorber solid material, and a predetermined humidity controlling material at least partially surrounding said adsorber solid material, thereby enabling using said adsorber solid material for interacting with and thus storing therein a predetermined adsorbable gas under desired environmental conditions.

48. The composition of claim 47, wherein said humidity controlling material is selected for maintaining a predetermined level of humidity.

49. The composition of claim 48, wherein the upper limit of said predetermined level of humidity is about 40%.

50. The composition of claim 47, wherein said adsorber solid material is selected from activated carbon, zeolite organometallic complexes, silica gel, alumina, polymers or any combination thereof.

51. The composition of claim 47, wherein said adsorber solid material is a porous material increasing the interface of the interaction between said adsorber solid material and said adsorbable gas molecules.

52. The composition of claim 47, wherein said humidity controller material is a selectively permeable membrane permitting passage of the adsorbable gas therethrough.

53. The composition of claim 47, wherein said humidity controller material defines a plurality of storage spaces located in between the adsorber solid material regions configured to bind molecules of the adsorbable gas to the adsorber solid material regions.

54. The composition of claim 53, wherein said plurality of adsorber solid material regions is distributed in a predefined three-dimensional spatial arrangement of spaced-apart regions increasing the surface area interface between said composition and said adsorbable gas.

55. The composition of claim 54, wherein said spatial arrangement is selected from at least one layer, a matrix, and a grid.

56. The composition of claim 47, comprises a plurality of humidity controller material embedded in at least one adsorber solid material having a matrix configuration.

57. The composition of claim 47, wherein said adsorber solid material has a predefined shape selected from spherical shape or elongated shape.

58. The composition of claim 47, wherein said humidity controlling material is selected from activated carbon, zeolite polymer silicon, latex, a metal, silica gel and alumina or any combination thereof.

59. The composition of claim 47, wherein said adsorber solid material is coated with said humidity controlling material.

60. The composition of claim 59, wherein said adsorber solid material is encapsulated by said humidity controlling material.
